(19) United States
(12) Patent Application Publication
(10) Pub. No.: US 2015/0288928 A1
(43) Pub. Date: Oct. 8, 2015

(54) SECURITY CAMERA SYSTEM USE OF OBJECT LOCATION TRACKING DATA

(71) Applicants: Sony Corporation, Tokyo (JP); Sony Network Entertainment International LLC, Los Angeles, CA (US)

(72) Inventors: Charles MCCOY, Coronado, CA (US); True XIONG, San Diego, CA (US)

(73) Assignees: Sony Corporation, Tokyo (JP); Sony Network Entertainment International LLC, Los Angeles, CA (US)

(21) Appl. No.: 14/247,698

(22) Filed: Apr. 8, 2014

(51) Int. Cl. H04N 7/18; G06F 17/30; H04N 5/44; G06K 9/00

(52) U.S. Cl. CPC H04N 7/18; G06K 9/00711; G06F 17/3028; H04N 5/44; H04N 7/181

(57) ABSTRACT

A dictionary/database of allowable and non-allowable conditions is used in a security camera system to generate alerts.

### FIELD OF THE INVENTION

The present invention is directed to a dictionary/database of allowable and non-allowable conditions for automatically tracking objects in a security camera system.

### BACKGROUND

The prior art uses various systems and methods to track objects. However, the prior art does not have a database or dictionary of allowable objects or actionable conditions to automatically track objects.

U.S. Pat. No. 8,345,102 is directed to object tracking. First, an object or objects are extracted from a background. Then one object is selected by a user. The object is then tracked in subsequent frames.

U.S. Publication No. 2007/0182818 is directed to tracking objects using multiple sensors is and video to trigger alerts based on an identified object and an. event. An event is determined from boolean logic to generate an alert. The event is determined from a variety of sensors and alert rules.

### SUMMARY

The present invention is directed to a dictionary/database of alerts including actionable items and visual or non-visual conditions used in a security camera system to generate actionable conditions and/or generate alerts.

The surveillance system includes a sensor system to detect objects, a dictionary/database of actionable conditions based on the objects and an analysis unit which analyzes the objects detected by the sensor system and determines if the analyzed objects are contained in the dictionary/database.

The sensor system may be a camera security system. The sensor system may detect visual objects. The sensor system may detect non-visual objects including radio frequency generating objects. The radio frequency generating objects may include cell phones.

The camera security system may include a plurality of cameras.

The actionable conditions include movement of predetermined objects within a particular area. The actionable conditions may include predetermined objects which should be excluded from being within a particular area. The actionable conditions may included objects identified is by law enforcement procedures.

Metadata may be inserted into frames of the surveillance video when an actionable condition is detected. The video may be highlighted, when actionable conditions are detected.

An alarm generating unit will generate an alarm when actionable conditions are determined by the analysis unit. The alarm generating unit may generate visual and audible alarms.

Other aspects of the invention will become apparent from the following description and drawings, all of which illustrate the principles of the invention by way of example only.

### BRIEF DESCRIPTION OF THE DRAWINGS

FIG. 1 shows a security system.

FIG. 2 shows a method of tracking an object.

### DETAILED DESCRIPTION

The present invention directed to a dictionary of actionable items in a surveillance video and a dictionary of actionable conditions.

The present invention is also directed to marking frames of a video with metadata in order to be distinguished when the video is later reviewed.

The present invention is directed to a dictionary/database of allowable and non-allowable conditions for automated object tracking.

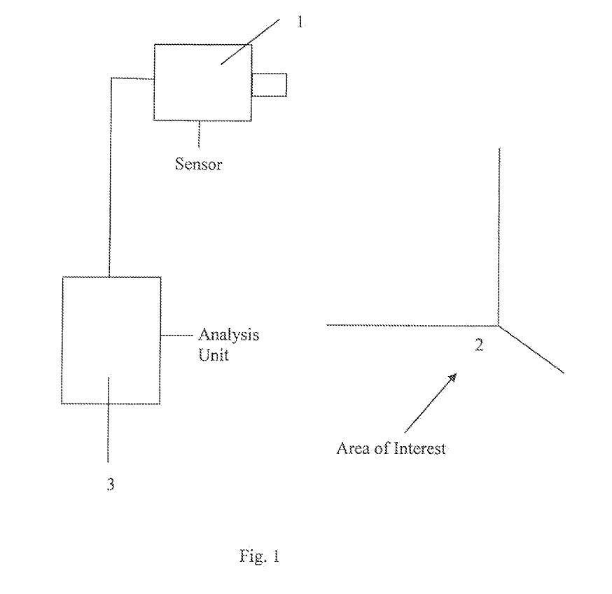

FIG. 1 shows a sensor I placed to observe an area of interest 2. The sensor 1 may be a camera, a plurality of cameras, and/or one or more sensor(s). The sensors may be a non-visual detector(s) such as radio-frequency detector(s). As an example, where the sensor is a camera, video is then input to an analysis unit 3 which analyzes the video to determine objects in the video, identify the objects, track them and determine if an actionable condition exists. The objects detection can be done in real time or can be based on recorded video and/or recorded sensor readings.

Analysis of the sensor output will detect objects that belong in an area and objects that do not belong in the area. For example, analysis of the sensor output can detect that more than a predetermined number of people are in an area thus creating a hazard. Thus, an alert can be is generated indicating that the number of occupants in the region exceed the number limited by the tire department. Furthermore, since analysis can be based on recorded sensor readings or prerecorded video, analysis can be done at a later time. For example a person of interest is identified after a crime has been committed. The video footage or sensor output from the day that the crime was committed is run through the analysis unit and compared against rules, added to the database after the video or sensor output was captured, for the person of interest.

Another example detects that certain objects should not be in a particular region such as knives in a child's playroom. A further example is analysis of the video shows a person with a backpack. Subsequent frame of the video show a separation of the person and the backpack indicating an actionable condition. Therefore, an alert can be issued if the separation time is greater than a predetermined amount of time.

A dictionary/database is created for actionable conditions. The actionable conditions are one or a series of events that are disallowed. Although the above examples show examples of visual items in an area, the system could also detect non-visible items using non-visual detectors. An example of non-visible items include detecting radio frequency (RF) emitting items. For example, a particular area may not allow RF emitting devices and detection thereof would cause an alert to be issued. An example would be prohibiting RF devices on an airplane. Another example would be to identify a particular RF object, such as a particular cell phone or RFID tag.

For example, a cell phone or a security badge carried by a security guard can be identified.

Thus, when a security guard is in an area under surveillance, metadata can be added to video captured by the security camera or can be added to each frame that the guard appears. Thus, existing objects can be used for tracking instead of an object that is specifically for tracking. Other examples of non -visual detectors include, but not limited to, motion detectors, pressure plates, audio detectors, chemical detectors (carbon monoxide, smoke, etc.), and those detectors that tell if an object breaks a beam of light.

A further example of video surveillance is to detect objects moving in an alarming direction, for example, in a tsunami where objects would be moving inland. The dictionary/database can contain a list of objects that should not be present in an area such as luggage or briefcase in an area where such items are not permitted or a teddy bear at a coronation. A dictionary/database can also be used to identify objects that leave an area under surveillance. The surveillance area can be anywhere were objects can be detected and may be one camera system or more than one camera system.

Once the video is analyzed and objects tracked, based on the tracked objects a dictionary/database of actionable conditions is searched in order to determine if an alert should be issued or an action should be taken. The dictionary/database of actionable conditions can be based on the location or movement of the objects, law enforcement procedures or other criteria.

Once an actionable condition is determined to be generated based on the dictionary/database, a visual or audible alert can be issued or an action by personnel can occur. Alternatively, frames of the video for which tracked objects are determined to be in the frame, can be inserted with metadata, indicating an action should be taken. Thus, when the video is replayed, due to the metadata, the frames will be highlighted or the tracked objects within the o frame will be highlighted so that the tracked object can be observed. Thus, a security camera system uses the tracking of objects to consider video to be of interest when the tracked objects move between flames. The video feed is thus marked with metadata to stand out during later review. This video feed can be highlighted on real time monitors, Another use of metadata is to find portions of video that are of interest. For example, using metadata, a security officer reviewing video can search through the video to view only portions of the video where certain objects or people are present in the video.

The visual and audible alarms can be triggered when tracked objects move. Alternatively, the security system camera can trigger alerts when objects other than a predetermined set are detected in a particular area. Also, the security camera system can trigger alerts when tracked objects leave a particular area. For example an actionable condition can trigger one or more displays to change the video that is being displayed. That is, the video feed displayed on one or more displays can be changed in response to an action identified by the analysis unit. For example, a large screen at a guard station can automatically switch to showing the video from a camera when the analysis unit identifies a particular object or person moving in the field of view of that camera, The video could further be augmented to highlight the object that triggered the display to be switched to show that video. The security camera system can log phone calls that are detected within a given area. Coordination of the location of the cell phones with images of the person carrying the cell phone can be detected. The logs can then be searched so that all activity for the cell phone in the monitored area can be automatically coordinated and summarized.

In addition, location tracking can he used to determine if an object is traveling in the wrong direction through an area that should only have movement in a single direction. For example, a person/object enters a secured area of an airport through an exit only hallway. The location of the tracked object can be coordinated with video surveillance of the exit only hallway to instantaneously provide images of the objects going the wrong way to security personnel as well as images of the people carrying the objects.

Some objects may contain trackers. For example, a security guard may wear a tracker. Therefore, the surveillance camera system can tell that the movement detected is a security guard, so that no actionable condition is generated. Similarly, if trackers are placed on objects that are not supposed to move, any detected movement by the objects would cause an alert or actionable condition to be issued.

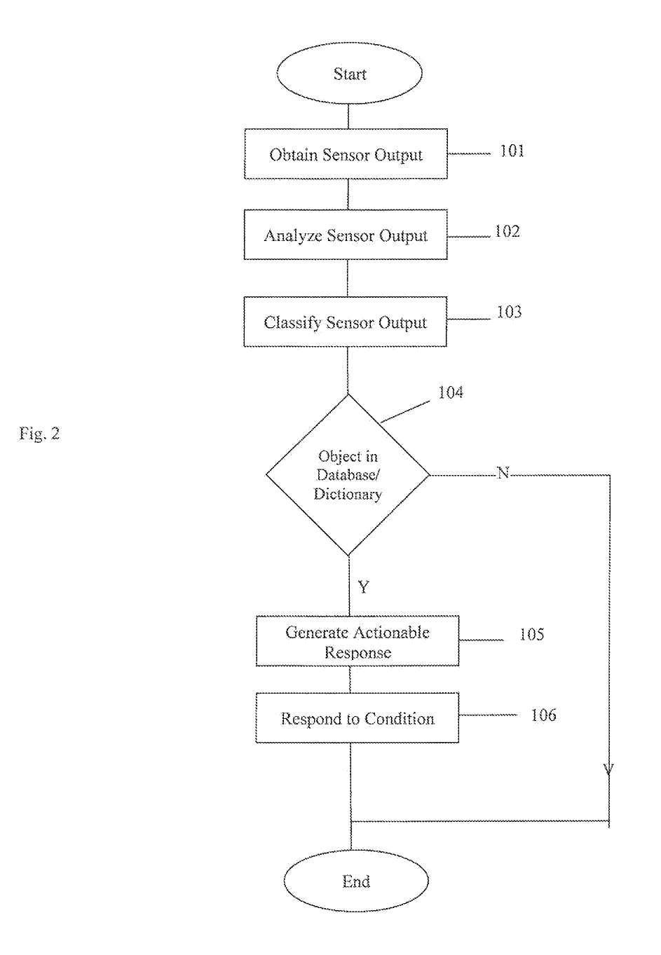

FIG. 2 shows a method of tracking an object. First, a sensor (s) and/or camera (s) obtains readings or images of a scene (Step 1041), Next, the scene is analyzed for objects within the scene (Step 102). The objects are classified into stationary and moving objects (Step 103). The objects detected are compared to objects identified in the dictionary/database as actionable conditions (Step 104). If the object is determined as actionable, generate an actionable response (Step 105) such as insert metadata into the frame of the video/image and/or generating an alert. Finally, (Step 106) a response to the actionable condition is performed such as reviewing video or responding to the alert.

With the present invention, objects can be tracked from surveillance video or other sources and actionable conditions can be automatically detected based on the location, law enforcement procedures or other criteria.

While the present invention has been described with reference to illustrative embodiments, this description is not intended to be construed in a limiting sense. Various modifications and combinations of the illustrative embodiments will be apparent to a person skilled in the art. Therefore, the appended claims encompass any such modifications or embodiments.

What is claimed is:

1. A surveillance system comprising:
a sensor system to detect objects;
a dictionary/database of actionable conditions based on the objects; and
an analysis unit analyzing the objects detected by the sensor system and determining whether the analyzed objects are contained in the dictionary/database, wherein the actionable conditions are one or a series of events.

2. The surveillance system according to claim 1, wherein the sensor system is a camera surveillance system.

3. The surveillance system according to claim 1, wherein the sensor system detects objects nonvisually.

4. The surveillance system according to claim 3, wherein the objects detected non visually include radio frequency emitting objects.

5. The surveillance system according to claim 4, wherein the radio frequency emit ti ng objects include cell phones.

6. The surveillance system according to claim 2, wherein the camera surveillance system includes a plurality of cameras.

7. The surveillance system according to claim 1, wherein the actionable conditions include movement of predetermined objects within a defined area.

8. The surveillance system according to claim 7, wherein movement of the predetermined objects is by entering the defined area.

9. The surveillance system according to claim 7, wherein movement of the predetermined Objects is by leaving the defined area.

10. The surveillance system according to claim 1, wherein the actionable conditions include predetermined objects which are excludible from a particular area.

11. The surveillance system according to claim 1, Wherein actionable conditions include objects identified by law enforcement procedures.

12. The surveillance system according to claim 1, further comprising an insert unit inserting metadata into video when an actionable condition is detected.

13. The surveillance system according to claim 1, wherein video is highlighted when an actionable condition is detected.

14. The surveillance system according to claim 1, further comprising an alarm generating unit generating an alarm when actionable conditions are determined by the analysis unit.

15. The surveillance system according to claim 14, wherein the alarm generating unit generates at least one visual alarm.

16. The surveillance system according to claim 14, wherein the alarm generating unit generates at least one audible alarm.

17. The surveillance system according to claim 1, wherein when an actionable condition is detected, video displayed on one or more displays is changed.

18. The surveillance system according to claim 1, wherein the analysis unit analyzes pre-recorded detections by the sensor system.
